(19) United States
(12) Patent Application Publication
(10) Pub. No.: US 2008/0209501 A1
(43) Pub. Date: Aug. 28, 2008

(54) System and method for implementing mandatory access control in a computer, and applications thereof

(75) Inventors: Frank L. Mayer, Ellicott City, MD (US); Spencer R. Shimko, Halethorpe, MD (US); Karl W. MacMillan, Silver Spring, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Tresys Technology, LLC, Columbia, MD (US)

(21) Appl. No.: 11/711,860

(22) Filed: Feb. 28, 2007

(51) Int. Cl. G06F 17/00

(52) U.S. Cl. 726/1

(57) ABSTRACT

Provided are systems and methods for implementing mandatory access control in a computer, and applications thereof. An embodiment provides a security policy generator that generates security policies for one or more machines of a network based on a single set of enterprise configuration parameters. This single set of enterprise configuration parameters comprises relatively few lines of text compared to a typical security policy file. The present invention makes it possible to easily configure, change, and adapt mandatory access control security policies to enforce application-specific security goals across many networked systems to create a single, distributed, secure enterprise. With the present invention, a network administrator, for example, can set familiar network and file configuration options that automatically result in security changes without requiring extensive knowledge of the operating system kernel or how to develop a mandatory access control security policy.

### FIELD OF THE INVENTION

The present invention is generally directed to computer security. More particularly, it is directed to implementing mandatory access control in a computer, and applications thereof.

### BACKGROUND OF THE INVENTION

Many computer operating systems have a security mechanism commonly referred to as access control. There are two main types of access control—discretionary access control and mandatory access control.

Under discretionary access control, system resources have security attributes (e.g., passwords and/or access control lists) associated with them. Access to system resources is controlled based on these security attributes, which are used to protect the system resources (e.g., files) owned by one user from unauthorized access by other users. A weakness associated with discretionary access control is that the security attributes assigned to each system resource are specified by the resource owner and can be modified or removed at will. During a computer attack, an attacker may be able to alter discretionary access control security attributes and thereby gain access to any or all system resources.

Under mandatory access control, access to system resources is controlled by security attributes that cannot be modified or removed during normal operation. In this way, mandatory access control offers a greater level of security compared to discretionary access control.

An example of mandatory access control is type enforcement. Type enforcement is implemented, for example, in security-enhanced Linux (SELinux). In type enforcement, both applications and system resources are assigned a type. Access for a type enforcement system such as SELinux is defined by a collection of rules contained in a file called a policy. A policy file is loaded into the operating system kernel of a machine during the boot process. The type attributes assigned to applications and system resources cannot be changed during normal operation.

Although mandatory access control such as type enforcement provides a greater level of security than discretionary access control, configuring the policy is difficult. The policy language of SELinux, for example, includes many complexities that must be well understood by a system developer before the system developer can create an effective security-enhanced system. Many system developers, however, do not have such an understanding. Therefore, many system developers cannot take advantage of the enhanced security offered by mandatory access control such as type enforcement.

What are needed are new techniques and tools for implementing mandatory access control that overcome the deficiencies noted above.

### BRIEF SUMMARY OF THE INVENTION

The present invention provides systems and methods for implementing mandatory access control in a computer, and applications thereof. In an embodiment, the present invention provides a security policy generator. The security policy generator generates security policies for one or more machines of a network based on a single set of enterprise configuration parameters. The enterprise configuration parameters may include, but are not limited to, IP addresses, ports, and network interfaces corresponding to the deployment environment. This single set of enterprise configuration parameters comprises relatively few lines of text compared to a typical security policy file.

The present invention makes it possible to easily configure, change, and adapt mandatory access control security policies to enforce application-specific security goals across multiple networked systems to create a single, distributed, secure enterprise. With the present invention, a network administrator, for example, can set familiar network and file configuration options that automatically result in security changes without requiring extensive knowledge of the operating system kernel or how to develop a mandatory access control security policy.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a diagram illustrating an example network having machines that implement mandatory access control.

FIG. 2 is a diagram illustrating an example multi-tier network.

FIG. 3 is a diagram illustrating a machine that implements mandatory access control.

FIG. 4A is a diagram illustrating communications between two machines that implement mandatory access control.

FIG. 4B is a diagram illustrating inter-process communications for a machine that implements mandatory access control.

FIG. 5 is a matrix illustrating example security requirements for the multi-tier network of FIG. 2.

FIG. 6 is a diagram illustrating an example method for obtaining configurable policy modules(s), a reference base policy, and enterprise configuration parameters.

FIG. 7 is a diagram illustrating an example method for generating installable binary policies.

FIG. 8 is a more detailed diagram illustrating operation of the translator of FIG. 7.

FIG. 9 is a more detailed diagram illustrating operation of the policy module generator of FIG. 7.

FIG. 10 is a diagram illustrating an example embodiment of the policy module generator of FIG. 7.

FIG. 11 is a diagram illustrating an example embodiment of the policy generator of FIG. 7.

FIG. 12A is a diagram illustrating operation of the policy source generator of FIG. 11.

FIG. 12B is a diagram illustrating operation of the binary complier of FIG. 11.

FIG. 13 is a diagram illustrating the distribution of policies to the machines of the multi-tier network of FIG. 2.

FIG. 14 is a diagram of an example computer system.

The features and advantages of the present invention will become more apparent from the detailed description set forth below when read in conjunction with the drawings. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The present invention provides systems and methods for implementing mandatory access control in a computer, and applications thereof. In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

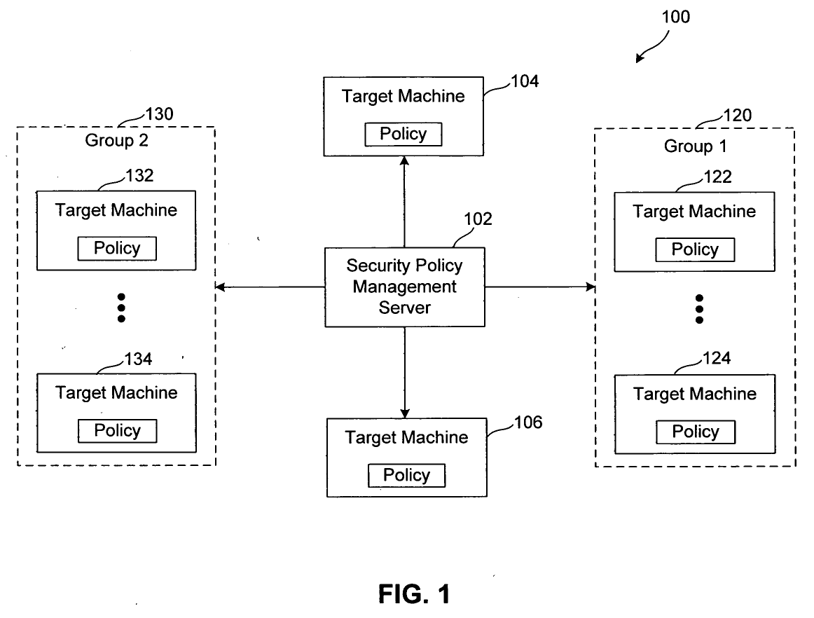

FIG. 1 is a diagram illustrating an example network 100 according to an embodiment of the present invention. As illustrated in FIG. 1, network 100 includes a security policy management server 102 and a plurality of target machines. The target machines of network 100 may be organized as single machines, like target machine 104 and target machine 106, or groups of machines, like group 120 and group 130. As shown in FIG. 1, the group 120 includes a plurality of target machines including a target machine 122 and a target machine 124. The group 130 includes a plurality of target machines including a target machine 132 and a target machine 134. Each target machine in network 100 includes a mandatory access control security policy.

In an embodiment, security policy management server 102 includes a security policy generator. The security policy generator generates the security policies for the target machines in network 100. As would be known to persons skilled in the relevant art(s), a typical security policy can include upwards of 50,000 lines of source code. It is a feature of the present invention, however, that network security policies can be generated in a simplified manner.

In an embodiment of the present invention, the security policy generator of security policy management server 102 generates the security policies for the machines of network 100 based on a single set of enterprise configuration parameters (e.g., the IP addresses, ports, and network interfaces corresponding to the deployment environment). This single set of enterprise configuration parameters may comprise, for example, as few as 50 lines of text, as opposed to upwards of 50,000 lines of source code.

As described in more detail below, it is a feature of the present invention that the enterprise configuration parameters needed by the security policy generator to generate the mandatory access control security policies can be provided, for example, by a network administrator responsible for network 100, in the form of a configuration file or by interacting with a graphical user interface (GUI). It is also a feature of the present invention that the security policies generated by the security policy generator can be configured to implement a common security objective for the deployment environment.

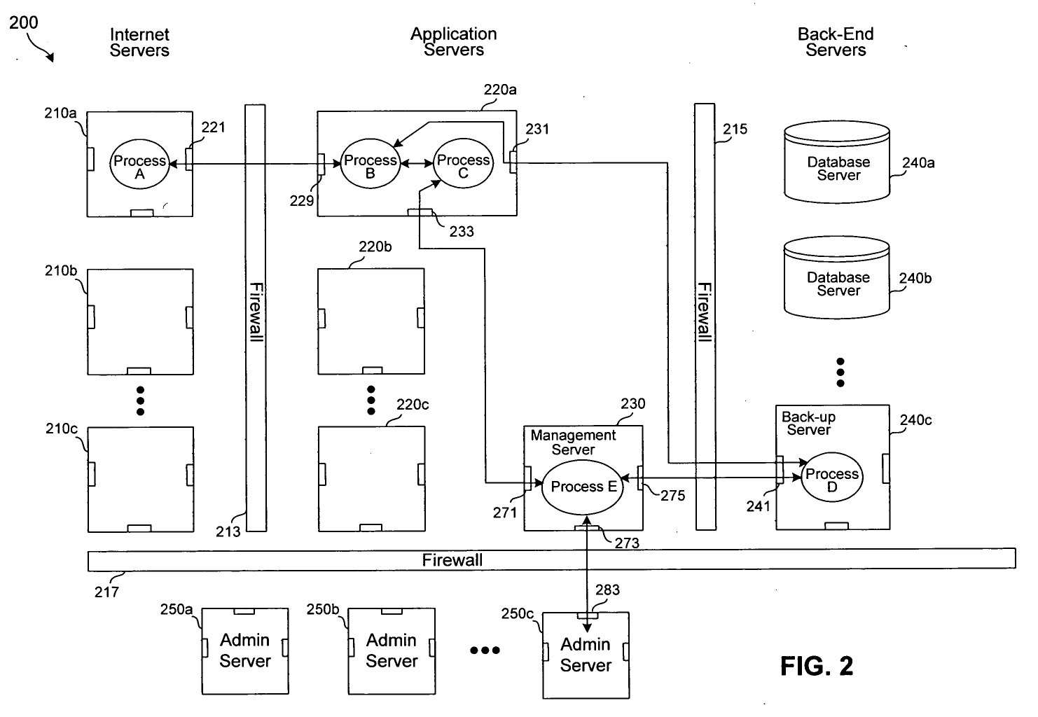

In order to better understand the present invention, consider the example multi-tier computer network 200 shown in FIG. 2. Computer network 200 includes: a tier of Internet servers 210a, 210b, and 210c; a tier of application servers 220a, 220b, 220c, with a management server 230; a tier of back-end servers 240a, 240b, 240c; and a tier of administration (admin) servers 250a, 250b, and 250c. The tiers of multi-tier computer network 200 are separated from each other by firewalls 213, 215, and 217.

As shown in FIG. 2, firewalls 213, 215, and 217 separate the machines included in computer network 200. Firewalls 213, 215, and 217 do not separate, however, processes that execute on the machines of network 200. As a result, a process executing on a first machine in a first tier of computer network 200 can potentially tunnel through a firewall to communicate with a process executing on a second machine in a second tier of computer network 200.

Because firewalls 213, 215, and 217 do not filter information at the process level, network 200 is vulnerable to attacks that are launched at the process level such as port attacks. For example, an attacker could potentially use a process A executing on Internet server 210a to gain access to a process D executing on back-up server 240c. If process A is corrupted by an attack, process A may perpetuate the attack by transmitting data over a network interface 221 on Internet server 210a that is received by process B over a network interface 229 of application server 220a. Network interfaces 221 and 229 may comprise, for example, Ethernet network interface cards. Process B may further perpetuate the attack by transmitting data over a network interface 231 of application server 220a that is received by process D over a network interface 241 of back-up server 240c. Under a different scenario, an attacker might use process A executing on Internet server 210a to gain access to admin server 250c. As in the previous example, process A executing on Internet server 210a may perpetuate an attack on the application servers by transmitting data to process B executing on application server 220a. As illustrated in FIG. 2, process B can communicate with a process C executing on application server 220a. Process C could then be used to continue the attack by transmitting data over a network interface 233 on application server 220a that is received by a process E over a network interface 271 of management server 230. Process E could then transmit data over a network interface 273 of management server 230 that is received by admin server 250c over a network interface 283.

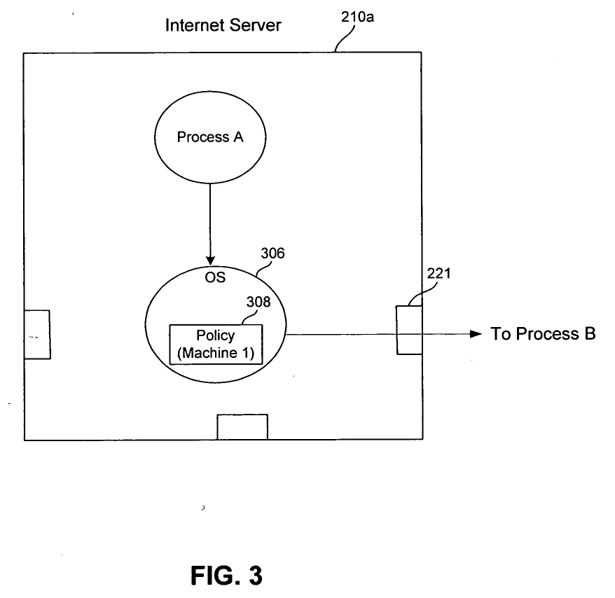

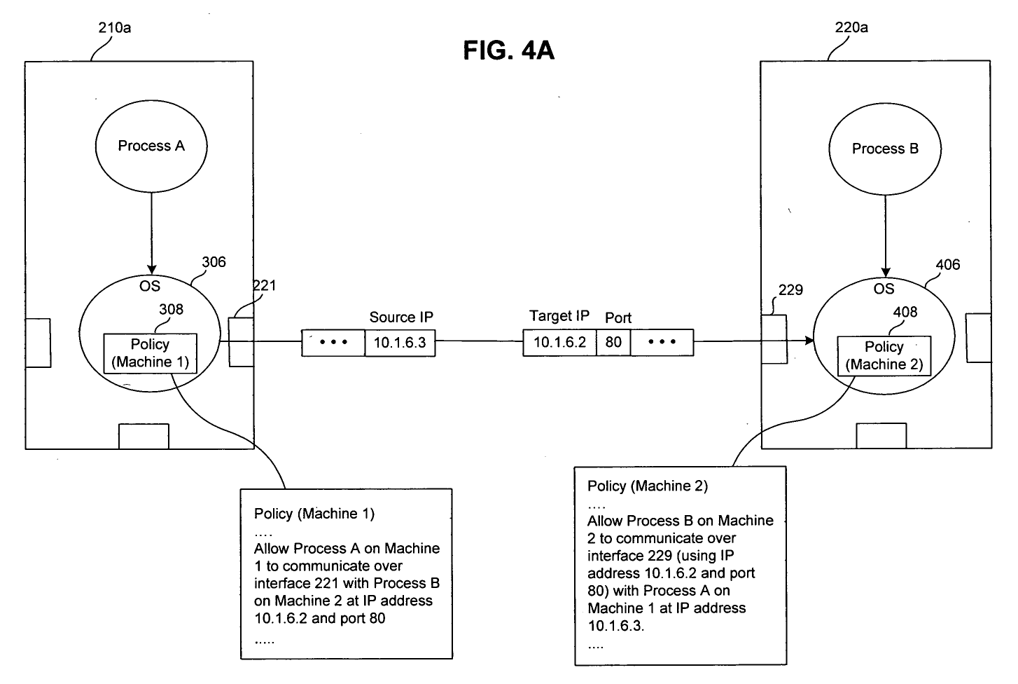

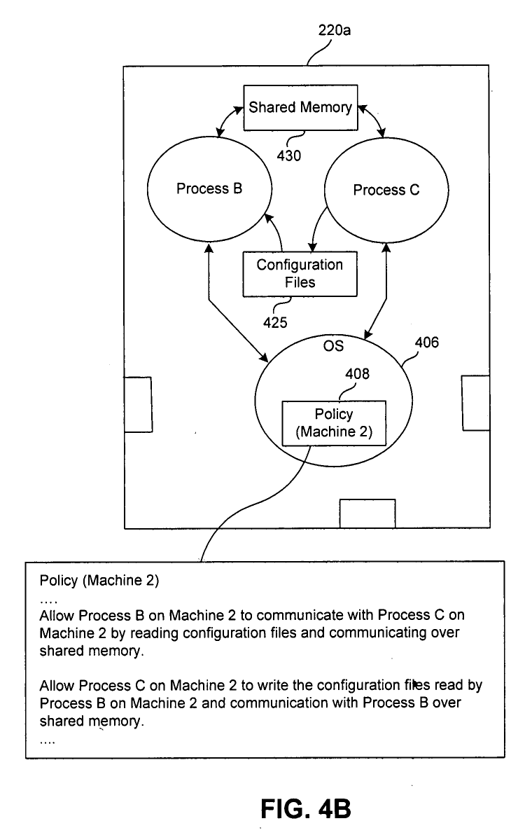

Vulnerability to the above described attacks can be reduced and/or eliminated by implementing mandatory access control such as type enforcement in accordance with the present invention. How mandatory access control works is illustrated by FIGS. 3, 4A, and 4B.

FIG. 3 is a diagram depicting an embodiment of Internet server 210a in which an operating system (OS) 306 implements a mandatory access control security policy 308. In an embodiment, application programs and network resources are defined with type attributes in accordance with security policy 308. If a process running on Internet server 210a such as process A attempts to communicate in a manner that violates a policy rule corresponding to the process's type, operating system 306 will not permit the process to communicate. For example, as shown in FIG. 3, if process A attempts to send data over network interface 221, operating system 306 first checks security policy 308 to determine whether the type corresponding process A is permitted to communicate over network interface 221. If this communication is allowed by security policy 308, operating system 306 sends the data. If, however, this communication is not allowed by security policy 308, operating system 306 does not send the data and optionally logs the attempted illegal communication.

As will be understood by persons skilled in the relevant art(s) given the description herein, a security policy such as security policy 308 specifies all the permissions granted to processes that execute on a machine such as internet server 210a. In other words, a process running on a machine can only communicate in manners that are allowed by the machine's security policy. A security policy for a machine will specify, for example, (1) whether a first process running on the machine may communicate with a process running on a second machine, or (2) whether the first process may communicate with a second process on the same machine. An example of (1) is described in more detail below with reference to FIG. 4A. An example of (2) is described in more detail below with reference to FIG. 4B.

FIG. 4A is a diagram illustrating how two security policies can be configured to control communications between a process A executing on Internet server 210a and a process B executing on application server 220a. As shown in FIG. 4A, Internet server 210a includes operating system 306 that enforces security policy 308. Application server 220a includes an operating system 406 that enforces a security policy 408.

Security policy 308 allows process A to communicate over network interface 221 with process B at IP address 10.1.6.2 using port 80. When process A attempts to send data to process B on application server 220a, the target IP address and port over which the data will be sent is included with the data, which in the example of FIG. 4A are 10.1.6.2 and 80, respectively. Because the security policy 308 allows process A to communicate over network interface 221 with process B at IP address 10.1.6.2 via port 80, operating system 306 permits the data to be transmitted.

On the receiving side, security policy 408 allows process B to communicate over network interface 229 (using IP address 10.1.6.2 and port 80) with process A at IP address 10.1.6.3. Operating system 406 checks the source IP address of the incoming data and the network interface over which the incoming data is received. Operating system 406 also checks the security policy 408 to determine whether process B is allowed to receive data from that source IP address over that network interface. Because security policy 408 allows process B to receive data from process A at IP address 10.1.6.3 over network interface 229, operating system 406 allows the transmitted data to be received by process B.

FIG. 4B is a diagram illustrating how a security policy controls communications between processes on a single machine, also referred to herein as inter-process communications (IPC). As shown in FIG. 4B, application server 220a includes a process B, a process C, configuration files 425, shared memory 430, and a security policy 408 enforced by operating system 406. Security policy 408 allows process B to communicate with process C, and vice versa. Specifically, process B is permitted to read configuration files 425 and communicate with process C over shared memory 430. Similarly, process C is permitted to write to configuration file 425 and communicate with process B over shared memory 430.

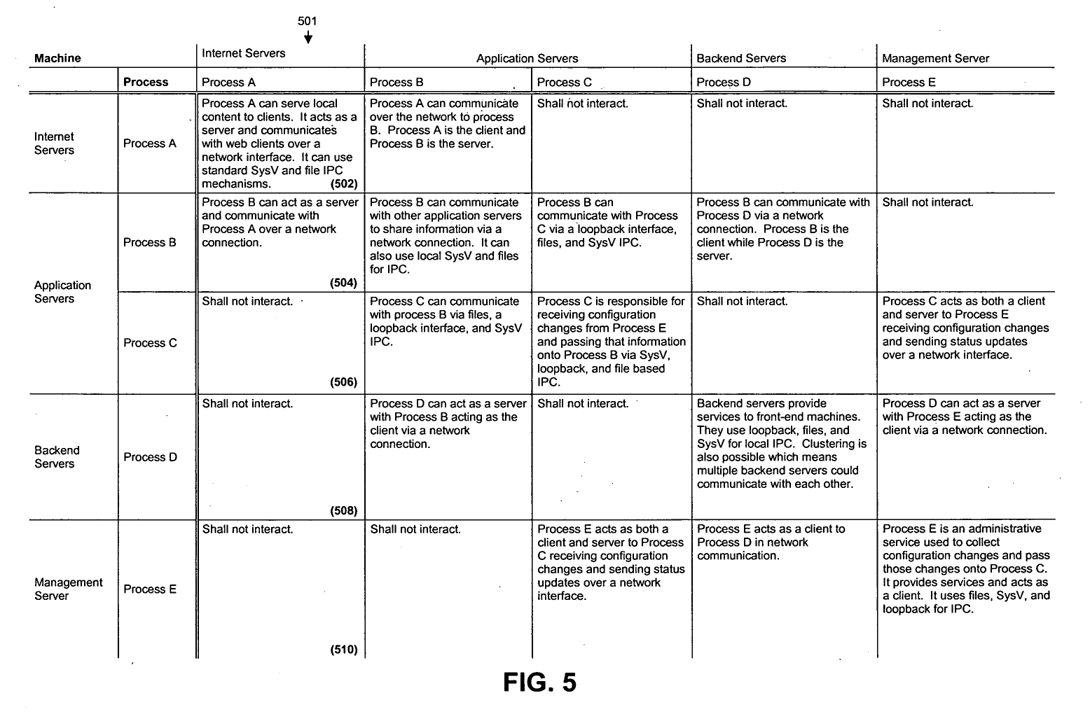

FIG. 5 is an example matrix that illustrates the type of communications allowed between the processes and machines included in example computer network 200 of FIG. 2 according to an embodiment of the present invention. The columns and rows of the matrix identify the various machines that make up computer network 200. As noted above, these machines include Internet servers, application servers, back-end servers, and a management server. The matrix in FIG. 5 also identifies the processes that execute on each of these machines. For example, process A executes on an Internet server, processes B and C execute on an application server, process D executes on a back-end server, and process E executes on the management server. The intersection of each column and row of the matrix in FIG. 5 specifies a security objective by defining the relationship between process(es) on the same machine or separate machines corresponding to the column and row.

As will be understood by persons skilled in the relevant art(s) given the description herein, the cells in column 501 specify the permissions granted to process A with respect to the processes on the other machines in computer network 200. Cell 502, for example, generally specifies the purposes of process A. In the example computer network 200, process A can serve local content to clients. More specifically, process A can act as a server and communicate with web clients over a network interface, and it can use standard UNIX System V (SysV) and file EPC mechanisms. Cells 504, 506, 508, and 510 respectively specify allowed communications (i) between process A (on the Internet server) and process B (on the application server), (ii) between process A and process C (on the application server), (iii) between process A and process D (on the back-end server), and (iv) process A and process E (on the management server). Referring to cell 504, process A can act as a server and communicate over the network to process B. As illustrated by cells 506, 508, and 510, process A shall not interact with process C, process D, or process E. Taken together, the cells of a particular column or a particular row of the matrix specify the security policy for a particular machine (e.g., column 501 specifies the security policy for an Internet server).

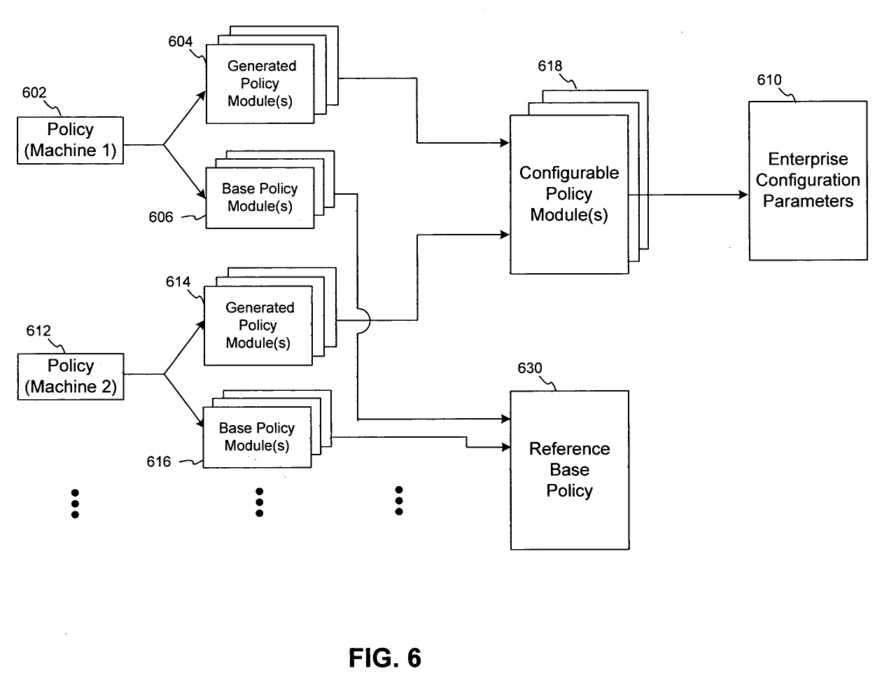

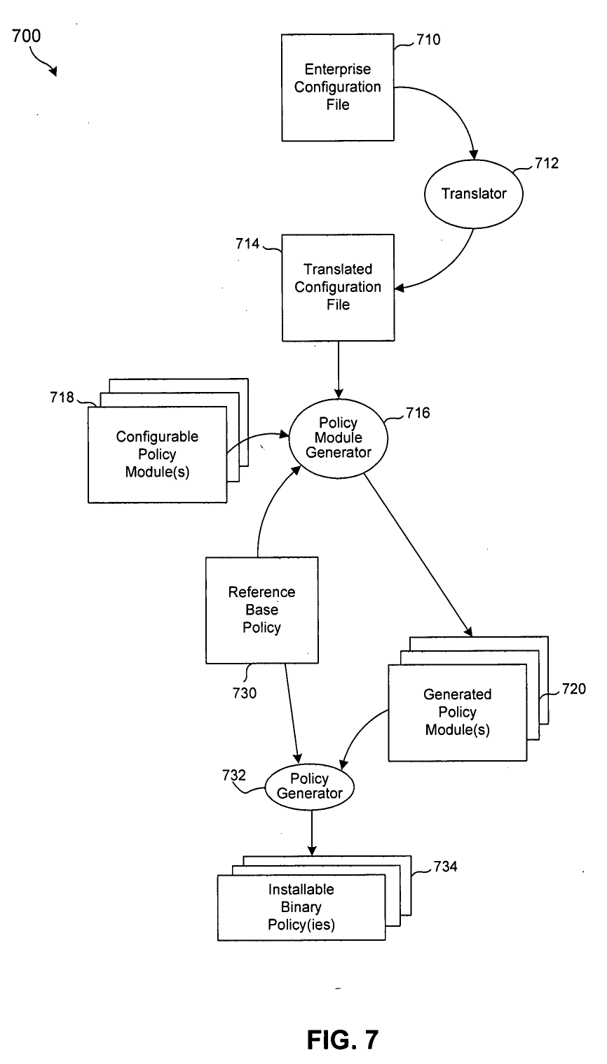

As noted herein, in an embodiment of the present invention, a security policy is generated by a security policy generator for each machine of a network. This is accomplished using configurable policy modules, a reference base policy, and enterprise configuration parameters as described in more detail below with reference to FIGS. 7-13. The relationships between these features of the present invention and individual machine policies are shown in FIG. 6. In order to generate machine policies for each of the various machines of computer network 200, according to an embodiment of the present invention, it is only necessary to provide the enterprise configuration parameters for network 200, for example, by a network administrator responsible for network 200, in the form of a configuration file or by interacting with a graphical user interface.

As noted above, FIG. 6 is a diagram illustrating a plurality of security policies—including a security policy 602 for a first machine and a security policy 612 for a second machine—that are implemented on machines of a network. As illustrated in FIG. 6, one or more generated policy modules 604 and one or more base policy modules 606 correspond to security policy 602. Similarly, one or more generated policy modules 614 and one or more base policy modules 616 correspond to security policy 612.

The one or more generated policy modules 604 and 614 corresponding to security policies 602 and 612 include specific network parameters values such as, for example, IP addresses, network interfaces, and ports that may vary between particular implementations or between different deployment environments. While these specific network parameters values may vary, generally speaking, the types of machines and their purposes will not vary for a particular type of computer network. Accordingly, the one or more base policy modules 606 and 616 corresponding to security policies 602 and 612 contain information that does not depend on specific network parameters values.

The one or more base policy modules 606 and 616 corresponding to security policy 602 and security policy 612 are a subset of the policy modules found in 630 for an entire network. Similarly, the one or more generated policy modules 604 and 614 from security policy 602 and security policy 612 are derived from one or more configurable policy modules 618 for the entire network. The enterprise configuration parameters 610 are used in combination with the configurable policy module(s) 618 to generate policies 602 and 612.

The following method can be used to generate the configurable policy module(s) 618 and the reference base policy 630 for a particular type of computer network or network architecture. First, the functionality of the particular network architecture can be exercised for a first deployment environment and audit logs can be generated for each machine in the network of that deployment environment. Second, the audit logs can be analyzed to determine how processes interact with the operating systems and other processes given this network architecture. Third, a security policy can be generated for each machine in the network corresponding to the first deployment environment. That is, the security policy will include policy rules based on the enterprise configuration parameters corresponding to the first deployment environment. Fourth, the first three steps can be repeated for another deployment environment and/or security objective, if necessary. Finally, as illustrated by FIG. 6, the security modules can be used to obtain configurable policy modules, a reference base policy, and to identify needed enterprise configuration parameters. From this, a security policy generator can be created, as described in more detail below.

FIG. 7 is a diagram illustrating an example security policy generator 700 in accordance with an embodiment of the present invention. As described below, security policy generator 700 can generate a security policy for each machine in a deployment environment based on enterprise configuration parameters provided by a user such as, for example, a network administrator. As described herein, the enterprise configuration parameters specify information that is specific to a particular deployment environment, such as IP addresses, network interfaces, ports, and filesystem structure (directories and files) of machines in that deployment environment.

Referring to FIG. 7, security policy generator 700 includes a translator 712 (optional), a policy module generator 716, and a policy generator 732. Translator 712 (optionally) translates an enterprise configuration file 710 to form a translated configuration file 714. Policy module generator 716 generates one or more generated policy modules 720 based on the translated configuration file 714, one or more configurable policy modules 718 (similar to configurable policy module(s) 618), and a reference base policy 730 (similar to reference base policy 630). Policy generator 732 generates one or more installable binary policies 734 based on the one or more configurable policy modules 718 and the reference base policy 730. Components of security policy generator 700 are described in more detail below.

Embodiments of security policy generator 700 are described below in terms of a particular network architecture corresponding to network software, known as WebSphere provided by International Business Machines (IBM) Corporation of Armonk, N.Y. This is for illustrative purposes only, and not limitation. Other embodiments of security policy generator 700 may be used to create security policies for machines in other network architectures and/or database management systems—such as, for example, the DB2 database management system provided by IBM—without deviating from the spirit and scope of the present invention.

Translator 712 translates enterprise configuration parameters from a format that depends on a particular network architecture (such as WebSphere) to a format that is independent of the particular network architecture.

Input to translator 712 is in the form of an enterprise configuration file 710. The enterprise configuration file 710 includes enterprise configuration parameters, such as IP addresses, network interfaces, and ports. A network administrator, for example, provides the enterprise configuration parameters by manually inputting data into a configuration file or by interacting with a graphical user interface (GUI). The enterprise configuration file 710 comprises relatively few lines of text compared to the security policy generated by security policy generator 700. For example, in a WebSphere deployment in which security policy generator 700 generates a customized SELinux security policy, the enterprise configuration file 710 may comprise approximately 50 lines of text; whereas, the customized SELinux security policy may comprise upwards of 50,000 lines of code (e.g., rules).

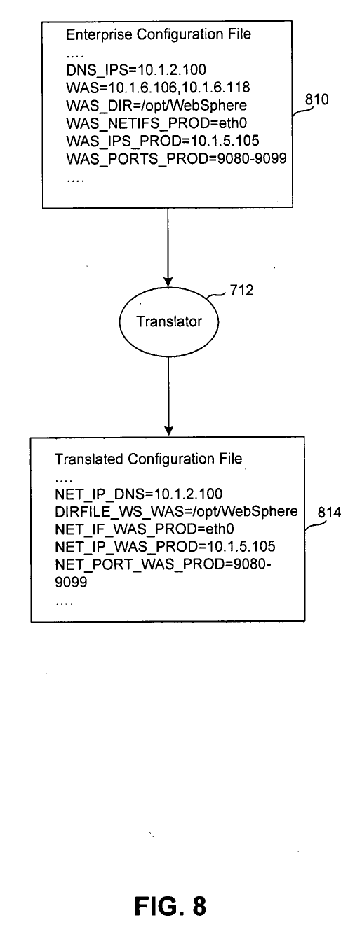

The enterprise configuration parameters included in the enterprise configuration file 710 are in a format specific to the particular network architecture of the deployment environment. For example, FIG. 8 is a diagram illustrating an embodiment of translator 712 specific to WebSphere. As illustrated in FIG. 8, input to translator 712 is in the form of an enterprise configuration file 810. The enterprise configuration file 810 provides information and requests data in a format that is familiar and intuitive to a WebSphere administrator. Accordingly, the WebSphere administrator can provide the enterprise configuration parameters by directly inputting data into the enterprise configuration file 810. In another embodiment (not shown), a user can interact with a GUI, and the enterprise configuration file 810 can be formed from the GUI.

Translator 712 translates the enterprise configuration file 810 to form a translated configuration file 814. Translated configuration file 814 includes the enterprise configuration parameters, but is in a format that is independent of the particular kind of network architecture. Referring to the example in FIG. 8, the translated configuration file 814 is in a format that is not specific to WebSphere, even though the enterprise configuration file 810 is in a format that is specific to WebSphere.

Because translator 712 provides an output that is independent of the particular network architecture, security policy generator 700 can be easily reconfigured to create security policies for any new type of network architecture. For each new type of network architecture, only translator 712 would need to be reconfigured-policy module generator 716 and policy generator 732 would not need to be reconfigured.

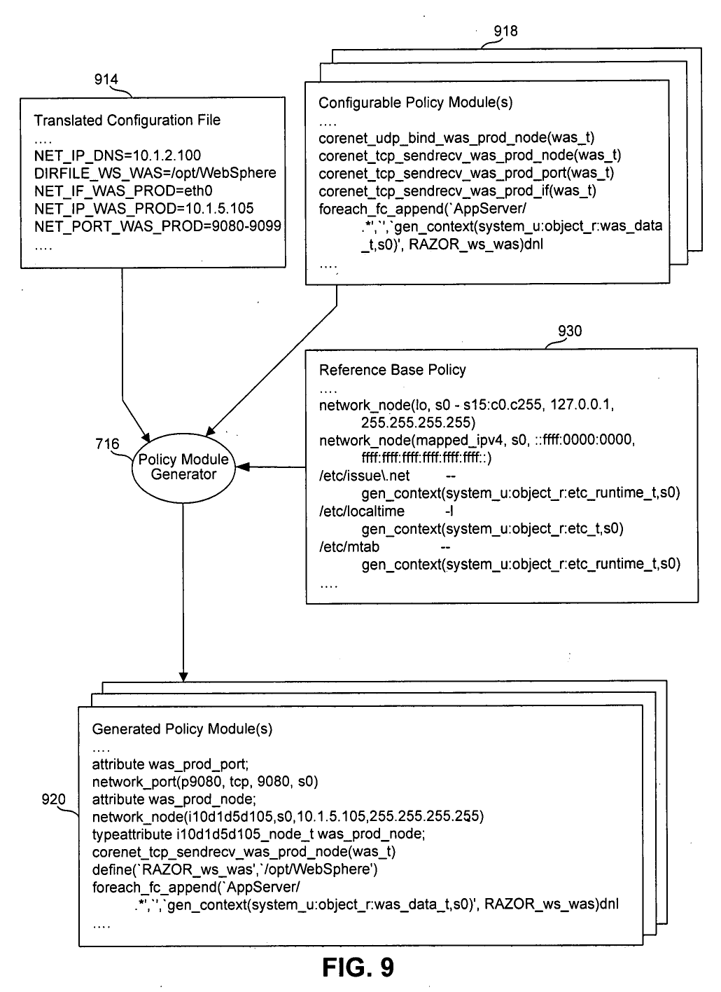

Policy module generator 716 generates one or more generated policy modules 720. Each generated policy module 720 comprises a portion of a security policy source file, such as an SELinux source file. The generated policy module(s) 720 include enterprise configuration parameters (such as IP addresses, network interfaces, ports, etc.) corresponding to a particular deployment environment. The generated policy module(s) 720, however, cannot be compiled into an installable binary policy, as described in more detail below. FIG. 9 depicts a generated policy module 920 that is specific to an example WebSphere deployment.

To generate the generated policy module(s) 720, policy module generator 716 receives several inputs. One of the inputs to policy module generator 716 is the enterprise configuration parameters. In an embodiment, the enterprise configuration parameters are included in an architecture-dependent format as provided, for example, by the enterprise configuration file 710. In another embodiment, the enterprise configuration parameters are included in an architecture-independent format as provided, for example, by the translated configuration file 714. For example, FIG. 9 depicts a translated configuration file 914 including enterprise configuration parameters specific to the example WebSphere deployment architecture.

Another input to policy module generator 716 is the configurable policy module(s) 718. The configurable policy module(s) 718 correspond to a particular type of architecture, such as WebSphere. Each configurable policy module 718 defines access for applications included in that architecture, but does not include information about the enterprise configuration parameters of the specific deployment environment. For example, the configurable policy module corresponding to Internet server 210a may specify that process A may communicate with process B on application server 220a, but would not include, for example, the IP addresses of Internet server 210a or application server 220a. In this way, the configurable policy module(s) 718 are portable between deployment environments. For example, the configurable policy modules corresponding to WebSphere can be used for any WebSphere deployment, FIG. 9 depicts configurable policy module(s) 918 including accesses for applications in the example WebSphere deployment.

Another input to policy module generator 716 is the reference base policy 730. The reference base policy 730 is a security policy, such as a security policy that is included with SELinux. SELinux is described in more detail, for example, in Bill McCarty, SELinux: NSA's Open Source Security Enhanced Linux (Andy Oram ed., 2005), and Frank Mayer et al., SELinux by Example (Prentice Hall, 2007), the entirety of each of the foregoing is incorporated by reference herein. Policy module generator 716 compares the configurable policy module(s) 718 to the reference base policy 730 to generate the generated policy module(s) 720, as described in more detail below. FIG. 9 depicts a reference base policy 930 including portions of source code from the base policy included with SELinux.

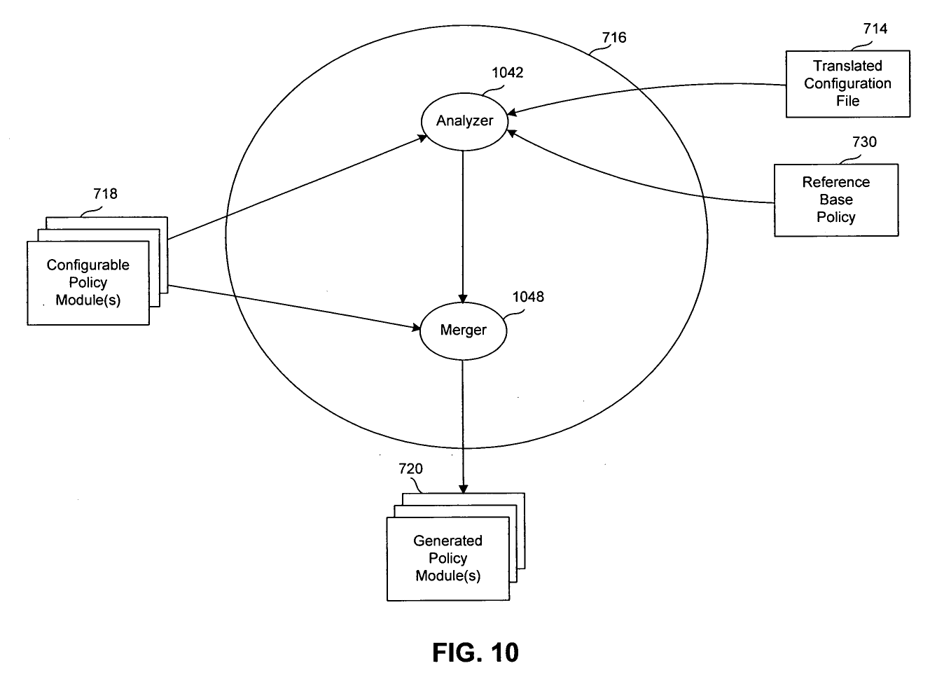

FIG. 10 depicts a block diagram illustrating an embodiment in which policy module generator 716 includes an analyzer 1042 and a merger 1048. Referring to FIG. 10, the analyzer 1042 analyzes the translated configuration file 714 and the configurable policy module(s) 718 to form one or more intermediate outputs comprising portions of security policy source files corresponding to a machine in a deployment environment. The intermediate output(s) are similar to the generated policy module(s) 720, but the intermediate output(s) may include policy rules that conflict with policy rules of the reference base policy 730. Analyzer 1042 compares policy rules of the intermediate output(s) with the policy rules of the reference base policy 730 to determine if there are any conflicts. If there is a conflict between a policy rule from the intermediate output(s) and a policy rule from the reference base policy 730, merger 1048 uses a conflict resolution algorithm to form the generated policy module(s) 720.

Policy generator 732 generates one or more installable binary policies 734 based on the generated policy module(s) 720 and the reference base policy 730. In particular, policy generator 732 generates an installable binary policy for each machine in a network. For the example of FIG. 2, policy generator 732 generates an installable binary policy for each Internet server 210, for each application server 220, for each back-end server 240, and for management server 230. In an embodiment, the one or more installable binary policies 734 are in the form of Red Hat Package Manager (RPM) files.

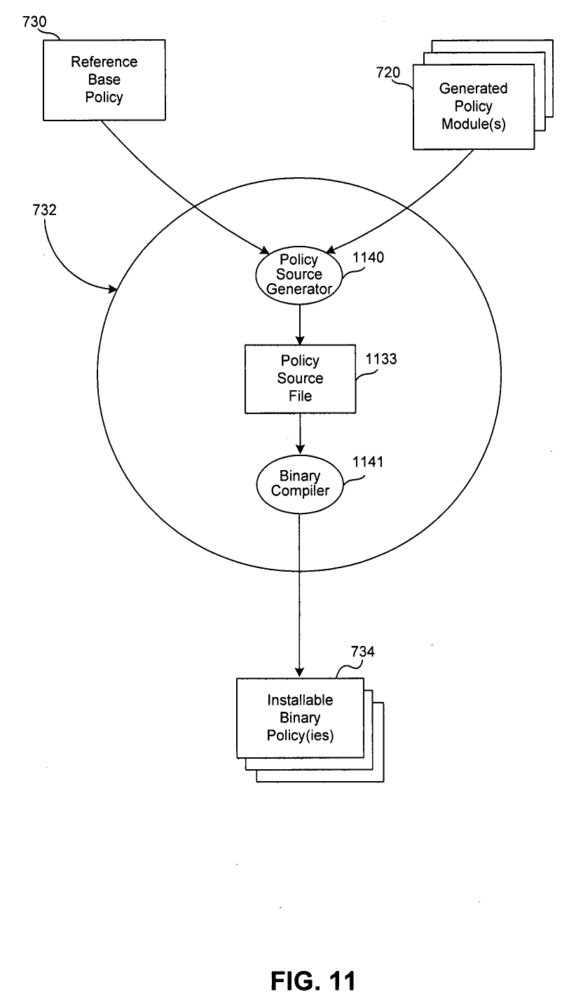

FIG. 11 depicts a block diagram illustrating an embodiment in which policy generator 732 includes a policy source generator 1140 and a binary compiler 1141. Policy source generator 1140 forms a policy source file 1133 based on the generated policy module(s) 720 and the reference base policy 730. Policy source file 1133 comprises a compilable policy source file that includes the customized security objectives specified by the enterprise configuration parameters provided, for example, by the administrator.

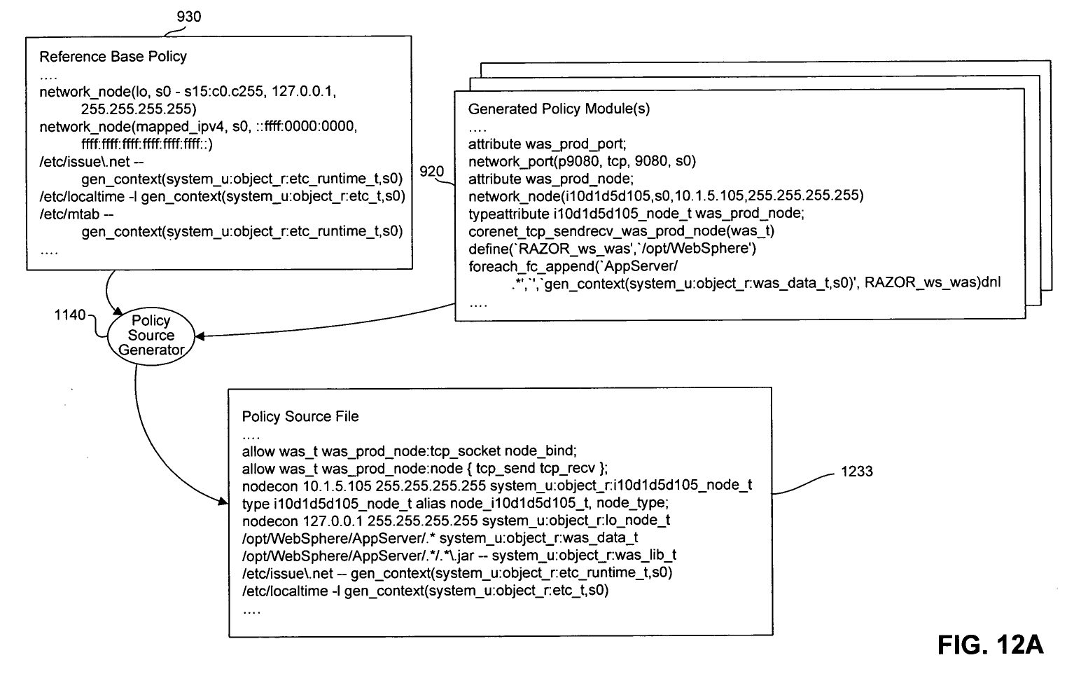

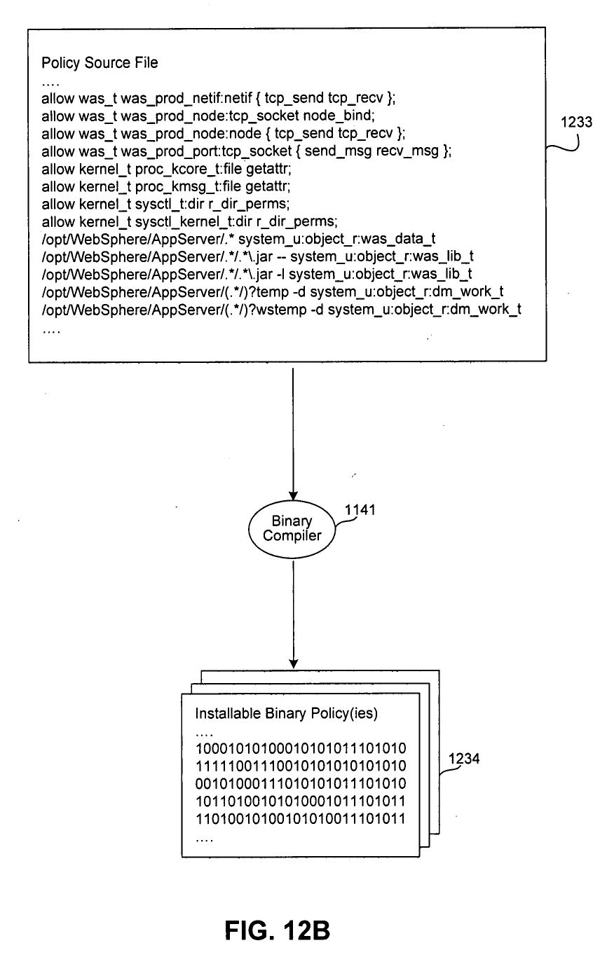

For example, FIG. 12A depicts a block diagram illustrating that policy source generator 1140 generates a policy source file 1233 comprising a customized SELinux policy corresponding to a WebSphere deployment. As illustrated in FIG. 12A, the reference base policy 930 and the generated policy module(s) 920 are input to policy source generator 1140. FIG. 12 B is a diagram illustrating that the binary compiler 1141 can generate one or more installable binary policies 1234 from the policy source file 1233.

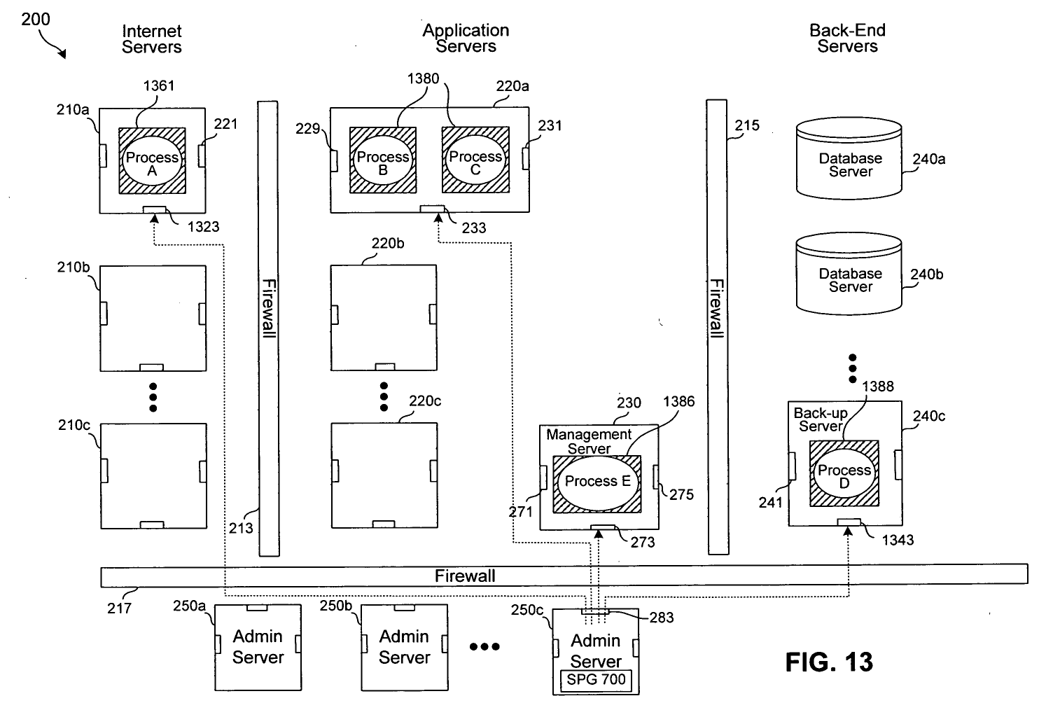

As described herein, a network administrator can easily create and distribute security policies for each machine in a computer network using security policy generator 700. For example, FIG. 13 illustrates the network 200, wherein admin server 250c includes security policy generator 700. The administrator can supply the enterprise configuration parameters (such as IP addresses, network interfaces, ports, directories) corresponding to the particular deployment environment of network 200, for example, by entering data into the enterprise configuration file 710. Based on these enterprise configuration parameters provided by the network administrator, security policy generator 700 generates a first installable binary policy for Internet server 210a, a second installable binary policy for application server 220a, a third installable binary policy for management server 230, and a fourth installable binary policy for back-up server 240c.

After generating the installable binary policies, admin server 250c can distribute the installable binary policies to the machines in network 200. For example, admin server 250c can send the first installable binary policy over a network interface 283 to Internet server 210a via an admin interface 1323. As a result, an installed policy 1361 provides security for process A on Internet server 210a.

Similarly, admin server 250c can send the second, third, and fourth installable binary policies to application server 220a, management server 230 and back-up server 240c via admin interfaces 233, 273, and 1343, respectively. As a result, an installed policy 1380 provides security for processes B and C on application server 220a, installed policy 1386 provides security for process E on management server 230, and installed policy 1388 provides security for process D on back-up server 240c.

Thus, as described herein, security policy generator 700 allows a network administrator to easily create and distribute security policies for each machine in a network.

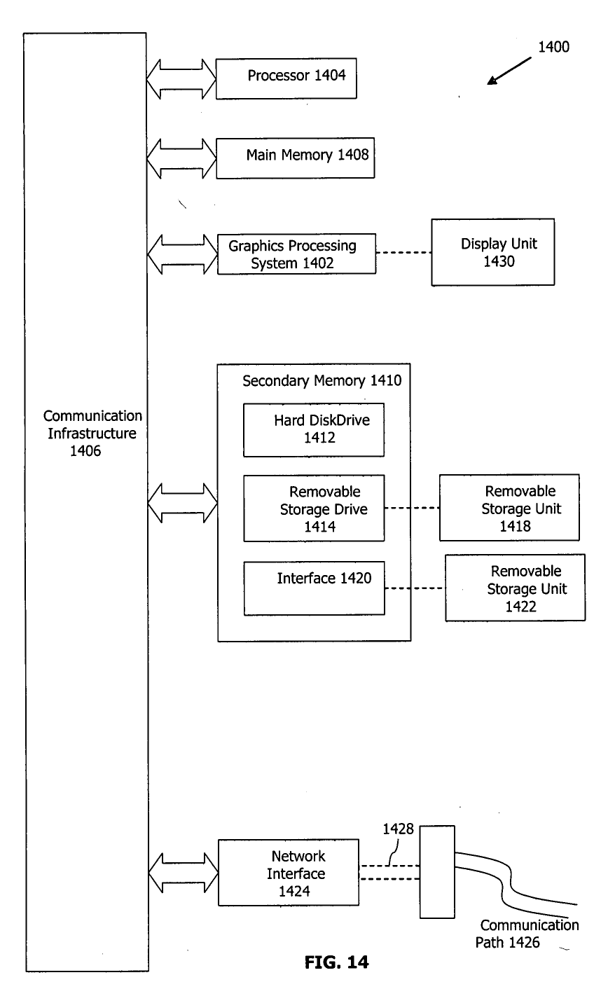

Various aspects of the present invention can be implemented by software, firmware, hardware, or a combination thereof. FIG. 14 illustrates an example computer system 1400 in which an embodiment of the present invention, or portions thereof, can be implemented as computer-readable code. Various embodiments of the invention are described in terms of this example computer system 1400. After reading this description, it will become apparent to a person skilled in the relevant art how to implement the invention using other computer systems and/or computer architectures.

Computer system 1400 includes one or more processors, such as processor 1404. Processor 1404 can be a special purpose or a general purpose processor. Processor 1404 is connected to a communication infrastructure 1406 (for example, a bus or network). Computer system 1400 may also include a graphics processing system 1402 for rendering images to an associated display 1430.

Computer system 1400 also includes a main memory 1408, preferably random access memory (RAM), and may also include a secondary memory 1410. Secondary memory 1410 may include, for example, a hard disk drive 1412 and/or a removable storage drive 1414. Removable storage drive 1414 may comprise a floppy disk drive, a magnetic tape drive, an optical disk drive, a flash memory, or the like. The removable storage drive 1414 reads from and/or writes to a removable storage unit 1418 in a well known manner. Removable storage unit 1418 may comprise a floppy disk, magnetic tape, optical disk, etc. which is read by and written to by removable storage drive 1414. As will be appreciated by persons skilled in the relevant art(s), removable storage unit 1418 includes a computer usable storage medium having stored therein computer software and/or data.

In alternative implementations, secondary memory 1410 may include other similar means for allowing computer programs or other instructions to be loaded into computer system 1400. Such means may include, for example, a removable storage unit 1422 and an interface 1420. Examples of such means may include a program cartridge and cartridge interface (such as that found in video game devices), a removable memory chip (such as an EPROM, or PROM) and associated socket, and other removable storage units 1422 and interfaces 1420 which allow software and data to be transferred from the removable storage unit 1422 to computer system 1400.

Computer system 1400 may also include a communications interface 1424. Communications interface 1424 allows software and data to be transferred between computer system 1400 and external devices. Communications interface 1424 may include a modem, a network interface (such as an Ethernet card), a communications port, a PCMCIA slot and card, or the like. Software and data transferred via communications interface 1424 are in the form of signals 1428 which may be electronic, electromagnetic, optical, or other signals capable of being received by communications interface 1424. These signals 1428 are provided to communications interface 1424 via a communications path 1426. Communications path 1426 carries signals 1428 and may be implemented using wire or cable, fiber optics, a phone line, a cellular phone link, an RF link or other communications channels.

In this document, the terms “computer program medium” and “computer usable medium” are used to generally refer to media such as removable storage unit 1418, removable storage unit 1422, a hard disk installed in hard disk drive 1412, and signals 1428. Computer program medium and computer usable medium can also refer to memories, such as main memory 1408 and secondary memory 1410, which can be memory semiconductors (e.g. DRAMs, etc.). These computer program products are means for providing software to computer system 1400.

Computer programs (also called computer control logic) are stored in main memory 1408 and/or secondary memory 1410. Computer programs may also be received via communications interface 1424. Such computer programs, when executed, enable computer system 1400 to implement embodiments of the present invention as discussed herein, such as security policy generator 700 of FIG. 7. In particular, the computer programs, when executed, enable processor 1404 to implement the processes of embodiments of the present invention. Accordingly, such computer programs represent controllers of the computer system 1400. Where the invention is implemented using software, the software may be stored in a computer program product and loaded into computer system 1400 using removable storage drive 1414, interface 1420, hard drive 1412 or communications interface 1424.

Various systems and methods for implementing mandatory access control in a computer, and applications thereof, have been described in detail herein. It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way. Furthermore, although aspects of the present invention have been described with reference to SELinux, the invention is not limited to the Linux operating system or SELinux. Based on the description contained herein, a person skilled in the relevant art(s) will appreciate that embodiments of the present invention can be implemented with regard to other operating systems.

What is claimed is:

1. A computer-implemented method for generating mandatory access control security policies, comprising:
(a) receiving a plurality of enterprise configuration parameters corresponding to a deployment environment;
(b) generating at least one generated policy module based on the enterprise configuration parameters, at least one configurable policy module, and a reference base policy; and
(c) generating at least one installable binary policy based on the at least one generated policy module and the reference base policy.

2. The computer-implemented method of claim 1, wherein (b) comprises:
analyzing the enterprise configuration parameters, the at least one configurable policy module, and the reference base policy to form an output; and
merging the output and the at least one configurable policy module to form the at least one generated policy module.

3. The computer-implemented method of claim 1, wherein (c) comprises:
generating a policy source file from the at least one generated policy module and the reference base policy; and
compiling the policy source file to form the at least one installable binary policy.

4. The computer-implemented method of claim 1, wherein (a) comprises receiving a configuration file that includes the enterprise configuration parameters.

5. The computer-implemented method of claim 1, wherein (a) comprises receiving a translated configuration file that includes the enterprise configuration parameters.

6. The computer-implemented method of claim 1, wherein (a) comprises receiving the enterprise configuration parameters from a graphical user interface.

7. The computer-implemented method of claim 1, wherein (a) comprises obtaining at least one Internet protocol (IP) address.

8. The computer-implemented method of claim 1, wherein (a) comprises obtaining at least one value associated with a network interface card.

9. The computer-implemented method of claim 1, wherein (a) comprises obtaining at least one number associated with a port.

10. The computer-implemented method of claim 1, wherein (a) comprises obtaining a name of a directory in which a file is located.

11. A computer program product comprising a tangible computer-readable storage medium that stores control logic to generate a security policy, the control logic comprising:
a policy module generator that generates at least one generated policy module based on enterprise configuration parameters corresponding to a deployment environment, at least one configurable policy module, and a reference base policy; and
a policy generator that generates at least one installable binary policy based on the at least one generated policy module and the reference base policy.

12. The computer program product of claim 11, wherein the policy module generator comprises:
an analyzer that analyzes the enterprise configuration parameters, the at least one configurable policy module, and the reference base policy to form an output; and
a merger that merges the output of the analyzer, the reference base policy, and the at least one configurable policy module to form the at least one generated policy module.

13. The computer program product of claim 11, wherein the policy generator comprises:
a policy source generator that generates a policy source file from the at least one generated policy module and the reference base policy; and
a binary compiler that generates the at least one installable binary policy from the policy source file.

14. The computer program product of claim 11, wherein the enterprise configuration parameters are included in an enterprise configuration file.

15. The computer program product of claim 14, further comprising:
a translator that translates the enterprise configuration file to generate a translated configuration file.

16. The computer program product of claim 14, further comprising a graphical user interface that is used to form the enterprise configuration file.

17. The computer program product of claim 15, further comprising a graphical user interface that is used to form the translated configuration file.

18. The computer program product of claim 11, wherein the enterprise configuration parameters comprise at least one Internet protocol (IP) address.

19. The computer program product of claim 11, wherein the enterprise configuration parameters comprise at least one value associated with a network interface card.

20. The computer program product of claim 11, wherein the enterprise configuration parameters comprise at least one number associated with a port.

21. The computer program product of claim 11, wherein the enterprise configuration parameters comprise a name of a directory in which a file is located.

22. A network computing system, comprising:
a security policy generator program that generates a first mandatory access control (MAC) security policy and a second MAC security policy based on enterprise configuration parameters corresponding to a deployment environment;
a first machine that implements the first MAC security policy; and
a second machine, coupled to the first machine, that implements the second MAC security policy;
wherein the first MAC security policy and the second MAC security policy collectively implement a network security objective.

23. The network computing system of claim 22, wherein the first machine and the second machine are separated by a firewall.

24. The network computing system of claim 22, wherein the first security policy and second security policy control communications between a first process on the first machine and a second process on the second machine.

25. The network computing system of claim 22, wherein the first security policy controls inter-process communications between a first process on the first machine and a second process on the first machine.
